(19) United States
(12) Patent Application Publication
(10) Pub. No.: US 2005/0243101 A1
(43) Pub. Date: Nov. 3, 2005

(54) Image generation apparatus and image generation method

(76) Inventors: Nobuo Sasaki, Kanagawa (JP); Takahiro Koguchi, Tokyo (JP)

Correspondence Address: KATTEN MUCHIN ROSENMAN LLP, 575 MADISON AVENUE, NEW YORK, NY, 10022-2585, US

(21) Appl. No.: 11/099,434

(22) Filed: Apr. 5, 2005

(30) Foreign Application Priority Data
Apr. 7, 2004 (JP) 2004-113137

(51) Int. Cl. G09G 5/00

(52) U.S. Cl. 345/601; 345/603; 345/604; 345/426; 345/582

(57) ABSTRACT

A texture unit is provided for performing texture mapping. A computation unit provides a separation unit with a texel value of a texture given by an index form. The separation unit takes an index value and an alpha value separately out of the texel value in the index form, and provides the index value to a lookup table reference unit and the alpha value to a synthesizing unit. Referring to a lookup table, the lookup table reference unit obtains an RGB value corresponding to the index value and provides the RGB value to the synthesizing unit. The synthesizing unit attaches the alpha value to the RGB value so as to generate color information of the texel and provides the color information to the computation unit. The computation unit performs a filtering processing such as bi-linear interpolation on the texture data based on the color information of the texel.

### BACKGROUND OF THE INVENTION

1. Field of the Invention

The present invention relates to an image generation apparatus and an image generation method which generate image data.

2. Description of the Related Art

In three-dimensional computer graphics, the polygon model, in which three-dimensional objects are generally represented by a larger number of polygons, is employed. In rendering objects using the polygon model, shading is performed in which the surface of polygons are shaded in consideration of light sources, view points and the reflectivity of objects' surfaces. In order to generate a photorealistic image, texture mapping, in which a texture image is mapped to the surface of polygon model, is performed.

In order to reduce the data amount of the texture image, an index color scheme might be adopted. In this scheme, each texel does not contain its color value but an index of the color value, and the index thereof is converted into an actual color value by referring to a color lookup table in performing the texture mapping. This scheme is also referred to as a color palette scheme. In the scheme, a color sample that defines the color values beforehand is prepared as a color lookup table or a color palette, and only index information for referring to the color lookup table is stored in each texel of the texture image. For instance, in the case of using the color sample with 256 colors, only an eight-bit index has to be stored in each texel of the texture image. In the case of the color sample with 16 colors, only a four-bit index has to be stored in each texel. Therefore the data amount of the texture image can be greatly reduced.

An alpha (a) value indicating transparency might be stored with RGB value in each entry of the color lookup table. There might be a correlation between drawing color and transparency depending on a rendering primitive, and it might be efficient for improving the compression efficiency of the texture to bring together the RGB value and the transparency in one as color information and to store the color information in the color lookup table.

However, there might be little correlation between the alpha value and the RGB value, for instance, when the transparency changes continuously on the surface of the polygon. For this case, if the color lookup table that stores the combination of the RGB value and the alpha value is generated while the accuracy of the alpha value is preserved, the number of combinations of three colors of RGB will be decreased resulting in degradation in the color quality. Conversely, if the color lookup table is composed where the accuracy of three colors of RGB is given a priority, it will set limits to the range of values that the alpha value may take and therefore the transparency cannot be changed continuously resulting in degradation in appearance.

Although it comes to be able to store the various combinations of the alpha value and the RGB value if the number of entries of the color lookup table is increased, the bit length of the index for referring to the color lookup table becomes large and it might impose a restriction on designing the system. Moreover, extra memory capacity is necessary to memorize the large size color lookup table and the area efficiency of the memory becomes worse.

### SUMMARY OF THE INVENTION

The present invention has been done in view of the aforementioned problems and its object is to provide an image generation apparatus and an image generation method capable of efficiently encoding drawing data with a limited memory capacity and generating an image of high quality.

According to one aspect of the present invention, an image generation apparatus is provided. The apparatus comprises: a lookup table which stores reference information in association with an index number; and a reference unit which refers to said lookup table based on an inputted index value and thereby obtains the reference information corresponding to the index value, wherein said lookup table stores a part of plural pieces of information necessary for performing an image generation processing and a remaining part of the plural pieces of said information which is not stored in said lookup table is appended to the index value so as to be provided directly.

The plural pieces of information necessary for performing an image generation processing are, for instance, color information, a function value and so forth. The color information is used herein as a broad concept, including not only an RGB value but also an alpha value indicating transparency and so forth.

The part of the plural pieces of said information stored in said lookup table may be a set of correlated pieces of said information with a relatively strong correlation to each other among the plural pieces of said information necessary for performing the image generation processing, and the remaining part of the plural pieces of said information appended to the index value may be a less-correlated piece of said information with a weak correlation to the set of the correlated pieces of said information. The correlation herein means an intension of a relation between two pieces of information. For instance, such an intension of the relation can be measured according to a correlation coefficient in multivariate analysis.

The part of the plural pieces of said information stored in said lookup table may be information describing pixel color, and the remaining part of the plural pieces of said information appended to the index value may be information describing a property other than the pixel color. The information describing a property other than the pixel color might be various information necessary for rendering, including, for instance, information on transparency, reflectance and refraction, and information on height or a normal vector in bump mapping.

According to another aspect of the present invention, an image generation apparatus is also provided. The apparatus comprises: a lookup table which stores reference information in association with an index number; a separation unit which takes an index value and a non-index value separately out of an inputted value; a reference unit which refers to said lookup table based on the index value and thereby obtains the reference information corresponding to the index value; and a synthesizing unit which synthesizes the reference information and the non-index value.

According to still another aspect of the present invention, an image generation apparatus is also provided. The apparatus comprises: a lookup table which stores reference information related to a texture in association with an index number; a separation unit which takes an index value and a non-index value separately out of an inputted value; a reference unit which refers to said lookup table based on the index value and thereby obtains the reference information corresponding to the index value; and a computation unit which processes texture data by utilizing said non-index value as information related to the texture, in addition to said reference information obtained by the reference unit.

According to still another aspect of the present invention, an image generation method is provided. The method comprises: receiving an input of an index value with additional information attached; referring to a lookup table which stores reference information necessary for performing an image generation processing in association with an index number and thereby obtaining the reference information corresponding to the inputted index value; and performing the image generation processing by using a combination of the obtained reference information and said additional information.

According to still another aspect of the present invention, an image generation method is also provided. The method comprises: taking an index value and a non-index value separately out of an inputted value; referring to a lookup table, which stores reference information necessary for performing an image generation processing, based on said index value and thereby obtaining said reference information corresponding to said index value; and performing the image generation processing by using said reference information and said non-index value.

According to still another aspect of the present invention, an image generation method is also provided. The method comprises encoding image information given by an index form, wherein said image information is configured such that a part of plural pieces of information necessary for performing an image generation processing is stored in a lookup table and a remaining part of the plural pieces of said information which is not stored in said look up table is appended to an index value for referring to said lookup table.

According to still another aspect of the present invention, a data structure of an image is provided. The data structure comprises encoded image information given by an index from, wherein said image information is configured such that a part of plural pieces of information necessary for performing an image generation processing is stored in a lookup table, and a remaining part of the plural pieces of said information which is not stored in said look up table is appended to an index value for referring to said lookup table.

According to still another aspect of the present invention, a data structure of a texture image is provided. The data structure comprises encoded image information given by an index form, wherein said image information is configured such that information describing a property other than texture color is appended to an index value for referring to a lookup table which stores information describing the texture color.

It is to be noted that any arbitrary combination of the above-described structural components and expressions changed among a method, an apparatus, a system, a computer program, a recording medium and so forth are all effective as and encompassed by the present invention.

Moreover, this summary of the invention does not necessarily describe all necessary features so that the invention may also be sub-combination of these described features.

### BRIEF DESCRIPTION OF THE DRAWINGS

FIG. 1 shows a structure of an image generation apparatus according to an embodiment of the present invention.

FIG. 2 shows a structure of a rendering block of FIG. 1.

FIG. 3 shows a structure of a texture unit of FIG. 2.

FIGS. 4A and 4B illustrate how a texel value given by an index form is converted.

FIG. 5 shows a structure of a lookup table that stores RGB values and alpha values.

FIGS. 6A and 6B illustrate how a texel value given by an index form is converted into color information based on a lookup table of FIG. 5.

FIG. 7 shows a structure of a lookup table that stores RGB values.

FIGS. 8A and 8B illustrate how a texel value given by an index form is converted into color information based on a lookup table of FIG. 7.

FIG. 9 is a flowchart showing a procedure of texture mapping process by a texture unit according to an embodiment.

FIG. 10 illustrates an example of setting an alpha value in rendering a complex shape.

FIG. 11 illustrates how an alpha value is decided on a boundary of a complex shape of FIG. 10.

### DESCRIPTION OF THE PREFERRED EMBODIMENTS

The invention will now be described by reference to the preferred embodiments. This does not intend to limit the scope of the present invention, but to exemplify the invention.

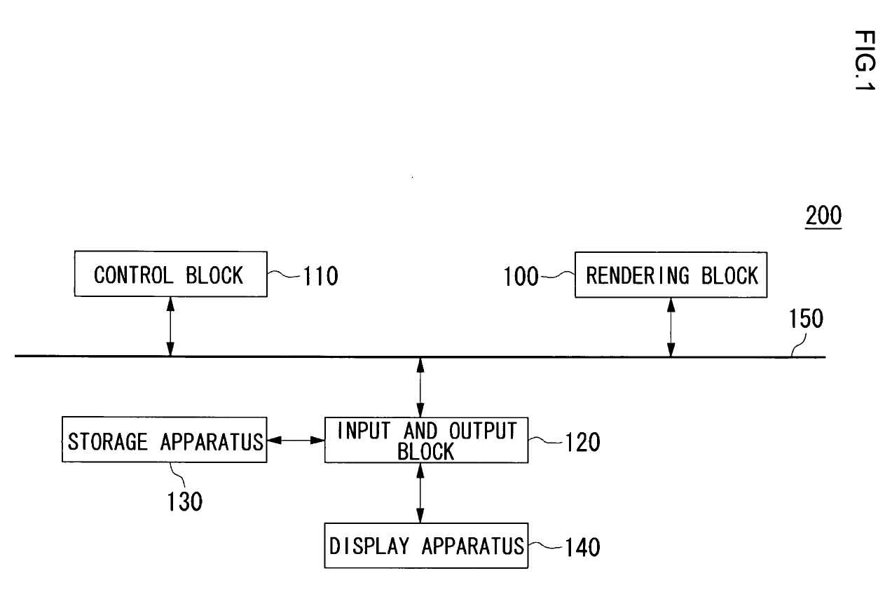

FIG. 1 shows a structure of an image generation apparatus 200 according to an embodiment of the present invention. The image generation apparatus 200 is comprised of a rendering block 100, a control block 110 and an input and output block 120 connected to each other via a bus 150. A storage apparatus 130 and a display apparatus 140 are connected to the input and output block 120. The input and output block 120 may communicate with other apparatuses via a network so as to import data necessary for rendering from an external source.

The control block 110 is a block that controls the entirety of the image generation apparatus 200. The control block 100 manages synchronization of data transfer between the interior of the image generation apparatus 200 and peripheral apparatuses such as the storage apparatus 130 and the display apparatus 140. The control block 110 is also responsible for management of interrupts from the individual units in the image generation apparatus 200, and management of a timer.

The input and output block 120 reads three-dimensional model information and various parameters stored in the storage apparatus 130 and provides the read data to the rendering block 100. The input and output block 120 may receive data necessary for rendering from an external apparatus via the network so as to provide the received data to the rendering block 100. The input and output block 120 displays rendering data output by the rendering block 100 to the display apparatus 140.

The rendering block 100 performs a rendering process by generating rendering data by referring to the three-dimensional model information supplied from the input and output block 120 and writing the generated data in a frame buffer.

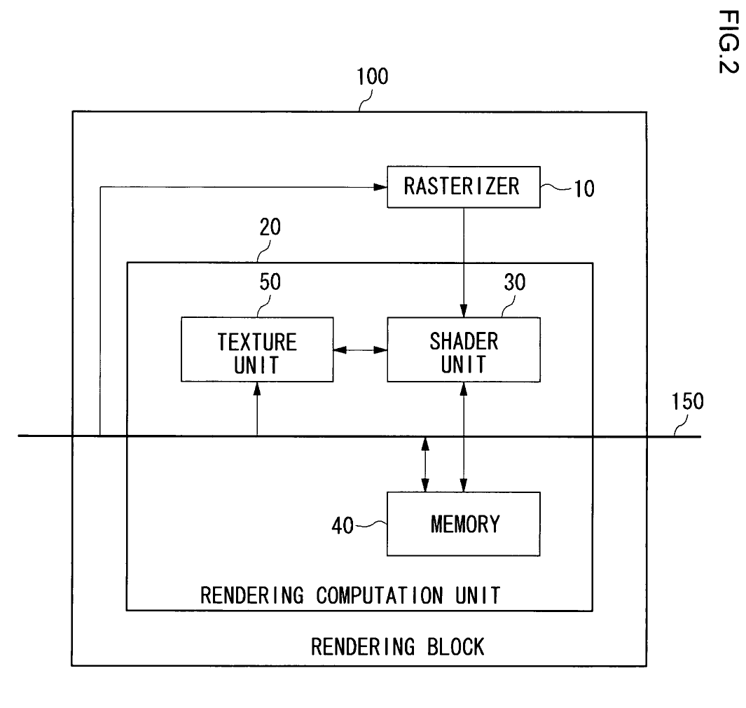

FIG. 2 shows a structure of the rendering block 100. A rasterizer 10 receives vertex data of rendering primitives from the input and output block 120. Generally, a rendering primitive is a triangle. The rasterizer 10 performs a view transform by projective transform of a triangle in the three-dimensional space into a triangle on a rendering plane. Further, the rasterizer 10 performs a raster process by scanning the triangle on the rendering plane in the horizontal direction so as to transform, row by row, the triangle into quantized pixels. The rasterizer 10 develop the rendering primitive into pixels and computes pixel information including an RGB color value, an α value and a Z value for each pixel.

The rasterizer 10 generates a pixel area (hereinafter, referred to as a rendering target area) of a predetermined size along the scan line and supplies the generated area to a rendering computation unit 20 in the subsequent stage. The rendering computation unit 20 includes a shader unit 30, a memory 40 and a texture unit 50. The memory 40 is provided with a frame buffer and a texture buffer. The frame buffer and the texture buffer may be provided in a single memory or physically separated memories.

The rendering target area supplied from the rasterizer 10 to the rendering computation unit 20 is stacked in a queue. The shader unit 30 sequentially processes the rendering target areas stacked in the queue.

The shader unit 30 performs a shading process by referring to pixel information computed by the rasterizer 10, determines pixel colors after texture mapping by referring to texel information obtained by the texture unit 50, and writes rendering data in the frame buffer in the memory 40. The shader unit 30 further performs processes like fogging and alpha blending on the rendering data held in the frame buffer so as to determine rendering colors ultimately to be reproduced, and updates the rendering data in the frame buffer. The rendering data stored in the frame buffer are read by the input and output block 120 and output to the display apparatus 140.

The texture unit 50 receives an input of parameters designating texture data from the shader unit 30, computes addresses of the texture data, and requests the texture buffer in the memory 40 to provide necessary texture data. The texture unit 50 caches the texture data read from the texture buffer, performs filtering processes such as bilinear interpolation and trilinear interpolation, and outputs resultant data to the shader unit 30.

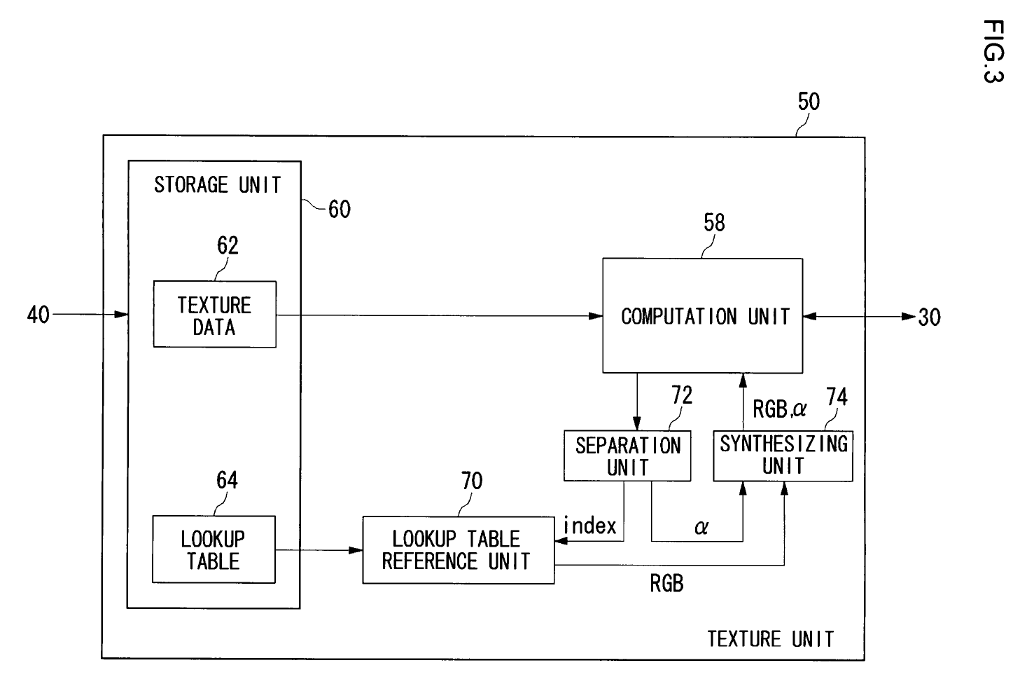

FIG. 3 shows a structure of the texture unit 50. The texture unit 50 computes addresses in the texture buffer by converting texture coordinates into texel coordinates, reads texel information in accordance with the computed addresses, and determines color information of the texels mapped to the pixels by a filtering process such as bilinear filtering. A description will now be given of a structure of the texture unit 50.

A computation unit 58 accepts inputs of a texture load command, a parameter acquisition command from the shader unit 30, processes the commands sequentially, and delivers results of the processes to the shader unit 30.

A texture load command includes texture parameters designating texture data. The texture parameters include texture coordinates, texel coordinates and a level of detail (LOD) value. The computation unit 58 applies a filtering process such as bilinear interpolation to the specified texture data.

A storage unit 60 stores texture data 62 and a lookup table 64. The storage unit 60 is used as a cache for holding the texture data 62 and the lookup table 64 read from the memory 40. The storage unit 60 provides the texture data 62 to the computation unit 58 in accordance with a request from the computation unit 58. Alternatively, the computation unit 58 may directly read the texture data 62 from the texture buffer in the memory 40, bypassing the storage unit 60.

The lookup table 64 is used as a color lookup table (CLUT) that stores texel color information which has been indexed. In addition, the lookup table 64 might be used as a general lookup table (LUT) which stores some other indexed information if necessary. The lookup table 64 is referred to by a lookup table reference unit 70. If the lookup table 64 is used as a general lookup table, the shader unit 30 could directly refer to the lookup table 64.

The texture data 62 does not have the color value itself of each texel but has an index for the color value as a texel value. Accordingly, the texture data 62 can be efficiently compressed. Information on the color value corresponding to the index value is stored in the lookup table 64 so as to be given as reference information. The lookup table 64 is configured such that its entries describing the color information are arranged in the numerical order of the index.

The computation unit 58 provides the texel value to a separation unit 72 to convert the texel value given by the index form into the color information. The separation unit 72 takes the index value separately out of the texel value in the index form and provides the index value to the lookup table reference unit 70. If a value other than the index value, which is hereinafter referred to as a non-index value, has been attached to the texel value in the index form, the separation unit 72 provides the non-index value to a synthesizing unit 74.

Referring to the lookup table 64, the lookup table reference unit 70 obtains the color value corresponding to the index value given from the separation unit 72, and provides the color value to the synthesizing unit 74. If the non-index value has been given from the separation unit 72, the synthesizing unit 74 synthesizes the non-index value given from the separation unit 72 to the color value given from the lookup table reference unit 70 so as to generate the color information of the texel, and provides the color information to the computation unit 58. If the non-index value has not been given from the separation unit 72, the synthesizing unit 74 provides the computation unit 58 with the color value given from the lookup table reference unit 70 as it is, as the color information of the texel. The computation unit 58 performs an operation such as bi-linear interpolation on the texture data according to the color information of the texel.

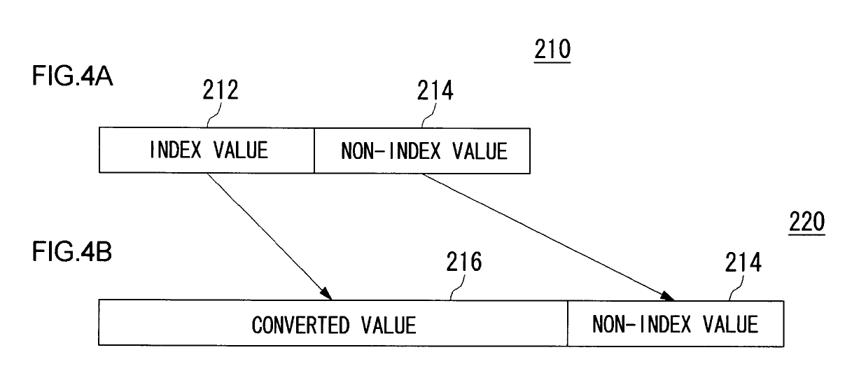

FIGS. 4A and 4B illustrate how the texel value given by the index form 210 is converted. The index form 210 is composed of the index value 212 and the non-index value 214 appended thereto as shown in FIG. 4A.

The separation unit 72 takes the index value 212 and the non-index value 214 separately out of the texel value given by the index form 210, and provides the index value 212 to the lookup table reference unit 70, and the non-index value 214 to the synthesizing unit 74. Referring to the lookup table 64, the lookup table reference unit 70 obtains a value corresponding to the index value 212, which is hereinafter referred to as a converted value 216, and provides the converted value 216 to the synthesizing unit 74.

The synthesizing unit 74 generates the color information 220 of the texel by appending the non-index value 214 included in the original index form 210 to the converted value 216 as shown in FIG. 4B, and provides the color information 220 to the computation unit 58.

It is to be noted that the non-index value 214 is an option, and the index form 210 might be composed of the index value 212 only. First, the case is described where the index form 210 is composed of the index value 212 only.

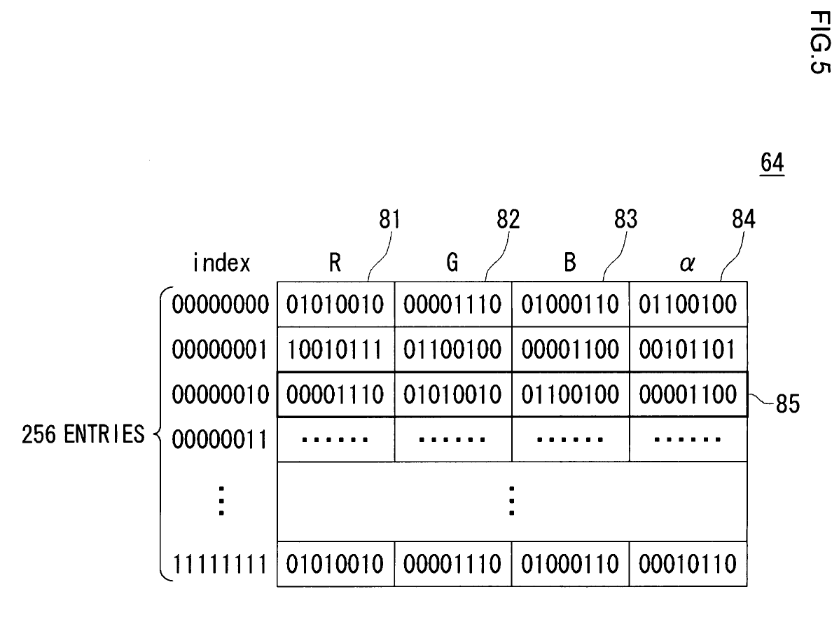

FIG. 5 shows a structure of the lookup table 64 that stores the RGB values and the alpha values. This lookup table 64 stores 256 entries of the color information, each of which is composed of a red (R) value 81, a green (G) value 82, a blue (B) value 83, and an alpha (a) value 84, in the numerical order of the index. The eight-bit index value 00000000 to 11111111 sequentially corresponds to each entry from the top to the bottom. For instance, the color information 85 in the third entry corresponds to the index value 00000010, and this color information 85 can be retrieved by referring to the lookup table 64 with the index value 00000010 specified.

Although the number of the entries of the lookup tables 64 is 256 since the eight-bit index is used in this example, the number of entries can be arbitrarily designed in general according to the bit number of the index. Moreover, the bit length of each entry may be freely designed according to the accuracy of the color and the alpha value to be represented, though each entry herein is composed of 32 bits as a whole since each color of R, G, and B and the alpha value are represented respectively by eight bits.

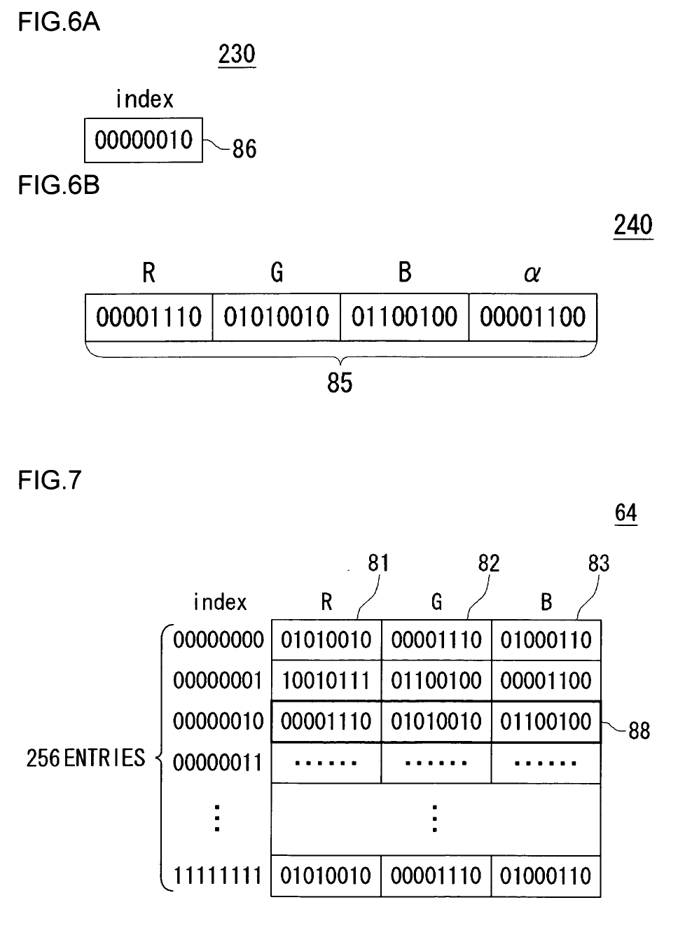

FIGS. 6A and 6B illustrate how the texel value given by the index form is converted into the color information based on the lookup table 64 of FIG. 5. If the texel value is given by the index form 230 which is composed of the index value 86 only as shown in FIG. 6A, the separation unit 72 provides the index value 86 as it is to the lookup table reference unit 70.

The lookup table reference unit 70 adds an offset value based on the index value 86 to the reference address for the lookup table 64, and reads an entry corresponding to the index value 86 from the lookup table 64. Thus, the lookup table reference unit 70 obtains the color information 85 corresponding to the index value 86 from the lookup table 64 of FIG. 5, and provides the color information 85 to the synthesizing unit 74.

The synthesizing unit 74 provides the computation unit 58 with the color information 85 itself given from the lookup table reference unit 70, as the color information 240 of the texel as shown in FIG. 6B, since the non-index value has not been given from the separation unit 72 in this case.

If there is a correlation between the RGB values and the alpha values, the color information composed of the RGB value and the alpha value is stored in the lookup table 64 as shown in FIG. 5. However, if there is no correlation between the RGB values and the alpha values or such a correlation is weak, only the RGB values are stored in the lookup table 64 and the alpha values are appended as the non-index values to the index values which are used for referring to the lookup table 64. Hereinafter, the case is described where the index form composed of the index value and the alpha value appended thereto is used.

FIG. 7 shows a structure of the lookup table 64 that stores the RGB values. The lookup table 64 stores 256 entries of the RGB values, each of which is composed of an R value 81, a G value 82 and a B value 83, in the numerical order of the index. The eight-bit index value 00000000 to 11111111 sequentially corresponds to each entry from the top to the bottom. For instance, the RGB value 88 in the third entry corresponds to the index value 00000010, and this RGB value 88 can be retrieved by referring to the lookup table 64 with the index value 00000010 specified.

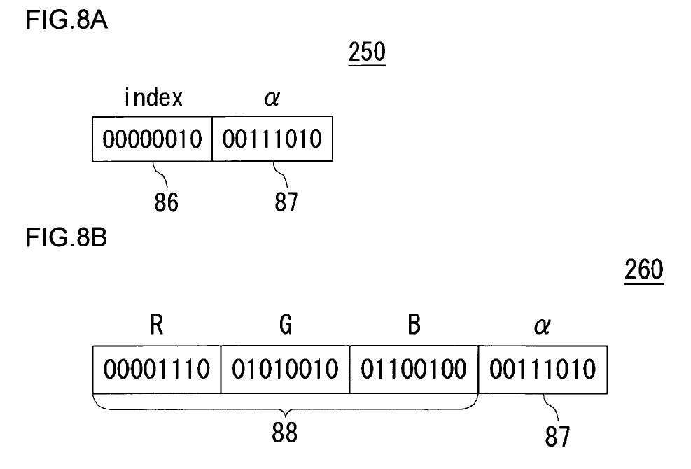

FIGS. 8A and 8B illustrate how the texel value given by the index form is converted into the color information based on the lookup table 64 of FIG. 7. If the texel value is given by the index form 250 composed of the index value 86 and the alpha value 87 as shown in FIG. 8A, the separation unit 72 takes the index value 86 and the alpha value 87 separately out of the index form 250, and provides the index value 86 to the lookup table reference unit 70, and the alpha value 87 to the synthesizing unit 74.

Referring to the lookup table 64 of FIG. 7, the lookup table reference unit 70 reads the RGB value 88 corresponding to the index value 86 and provides the RGB value 88 to the synthesizing unit 74. As shown in FIG. 8B, the synthesizing unit 74 synthesizes the RGB value 88 that the lookup table reference unit 70 has read from the lookup table 64 and the alpha value 87 that the separation unit 72 has taken out of the index form 250, and thereby generates the color information 260 of the texel composed of the R value, the G value, the B value, and the alpha value. The synthesizing unit 74 provides the color information 260 to the computation unit 58.

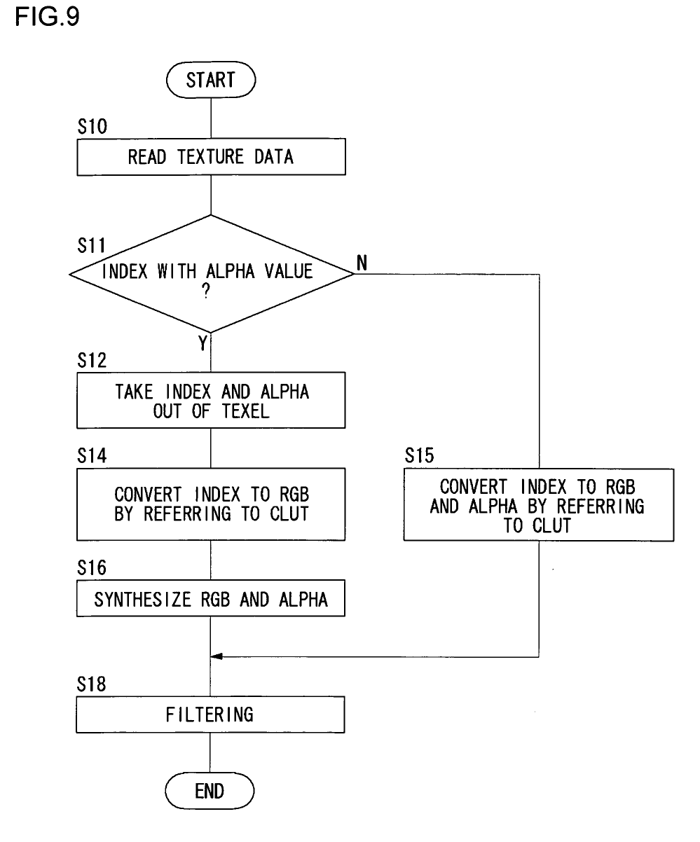

FIG. 9 is a flowchart showing the procedure of the texture mapping process by the texture unit 50.

The computation unit 58 reads the texture data 62 in the storage unit 60 based on the texel coordinates (u,v) (S10).

If the texture data 62 is given by the index form in which the alpha value is appended to the index value (Y of S11), the separation unit 72 takes the index value and the alpha value separately out of the texel value (S12). The lookup table reference unit 70 converts the index value into the RGB value by referring to the lookup table 64 whose type is shown in FIG. 7 (S14). The synthesizing unit 74 attaches the alpha value to the RGB value obtained from the lookup table 64, and thereby generates the color information of the texel (S16).

If the texture data 62 is given by the index form composed of the index value only (N of S11), the separation unit 72 provides the index value to the lookup table reference unit 70 and the lookup table reference unit 70 converts the index value into the color information composed of the RGB value and the alpha value by referring to the lookup table 64 whose type is shown in FIG. 5 (S15).

The computation unit 58 performs a filtering process such as bi-linear interpolation according to the operation mode based on the obtained color information of the texel (S18).

The method by which the alpha value alone is appended to the index instead of being stored in the lookup table 64 is effective especially in the case where the alpha value may take various values in the area to be rendered regardless of the RGB value of the pixel. Hereinbelow, such the case is exemplified.

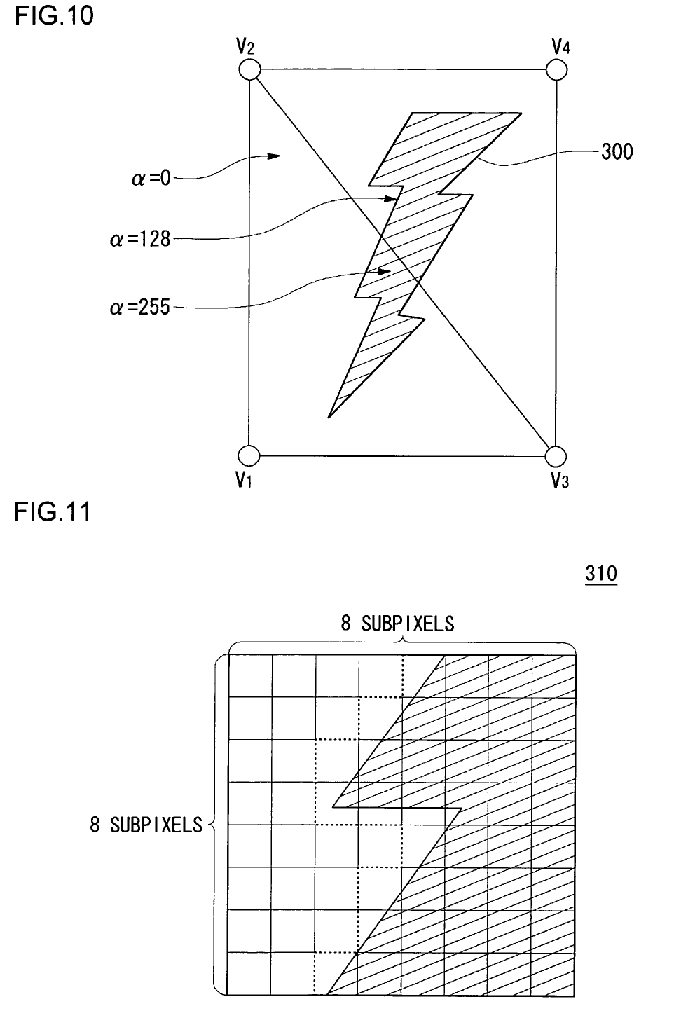

FIG. 10 illustrates an example of setting the alpha value in rendering a complex shape. The quadrangle whose vertices are the four points v1-v4 is divided into a strip of two triangles to be rendered as shown in the figure. The texture is mapped to the triangle whose vertices are v1, v2, and v3 and the triangle whose vertices are v2, v3 and v4, to render the complex shape 300. The shape 300 actually takes a complicated shape in detail, however, the figure illustrates the shape briefly. If the alpha value is given by eight bits, the alpha value takes zero outside the shape 300 and the alpha value takes 255 inside the shape 300. The alpha value takes a mean value from 1 to 254 at the boundary of the shape 300. The smaller the alpha value is, the higher transparency is. If the alpha value is zero, the pixel to be rendered is completely transparent, and if the alpha value is 255, the pixel is completely opaque.

When the texture is mapped to a complex shape such as a tree or a leaf, whose boundary is complicated, the resolution could be raised in appearance by blending the rendering object with the background while continuously changing the alpha values for the rendering object on its boundary. This texture rendering technique is hereinafter referred to as “alpha texture”. In the case of such an alpha texture, the alpha value changes continuously on the boundary of the rendering object so that the alpha value may take almost all the mean values between from 1 to 254, when the alpha value is represented, for instance, by eight bits. Therefore, the correlation between the alpha value and the RGB value is almost lost on the boundary.

FIG. 11 illustrates how the alpha value is decided on the boundary of the shape 300 of FIG. 10. One pixel 310 on the boundary is divided into eight subpixels each in the vertical and the horizontal directions, that is, 64 subpixels in total. When the shape 300 of FIG. 10 occupies the area shaded by oblique lines inside the one pixel 310 as shown in the figure, the number of subpixels in which any portion of the shape 300 exists is counted. In the example of this figure, any portion of the shape 300 exists inside the subpixels at the right hand beyond the dotted line, and the number of these subpixels is 41. Then, the alpha value for this pixel is calculated as α=(41/64)·255=163.

In FIG. 10, the alpha value inside the shape 300 takes a value of 255. Even if the RGB values of the texture to be mapped to the shape 300 may take a wide range of values, the range of values that the alpha value may take is limited to only one value of 255, and therefore a strong correlation appears between the occurrence frequency of the RGB value and that of the alpha value. However, the correlation hardly appears between the occurrence frequency of the RGB value and that of the alpha value on the boundary of shape 300, because the alpha value may take all the values from 1 to 254 as described in FIG. 11.

For this case, if both the RGB value and the alpha value are stored in the lookup table 64, the number of combinational patterns of the RGB values must be decreased in order to keep the precision of the alpha value, under a condition that the number of the entries of the lookup tables 64 is kept constant. Conversely, the number of the patterns of the alpha value must be decreased in order to keep the precision of the RGB values.

Therefore, the texture with the alpha value attached is configured such that only the RGB value is stored in the lookup table 64 and the alpha value is directly given by being appended to the index value for referring to the lookup table 64, and the resultant texture image is compression-encoded. Thereby, the memory capacity is efficiently utilized and the efficiency for encoding the texture can be raised, and at the same time the rendering quality can be improved.

Described above is an explanation of the present invention based on the embodiment. The description of the embodiment is illustrative in nature and various variations in constituting elements and processes involved are possible. Those skilled in the art would readily appreciate that the variations are also within the scope of the present invention.

Such variations are described hereinbelow. In the description given above, the alpha value has been exemplified as the non-index value to be appended to the index value, however information to be appended to the index value is not limited to the alpha value. For instance, a reflection coefficient indicating reflectivity of the pixel may be appended to the index value. Since the correlation between the RGB value and the reflection coefficient is weak in the area to be rendered, it would be reasonable that the RGB value is stored in the lookup table 64 while the reflection coefficient is directly appended to the index value instead of being stored in the lookup table 64. By this configuration, a limited capacity for the table is effectively utilized without sacrificing the degree of freedom for allocating various RGB values in the table.

Moreover, in the above description, the color information such as the RGB value and the non-color information that indicates transparency, reflectivity or the like are provided separately, and the color information is stored in the lookup table 64 and the non-color information is appended to the index value. However, it is not necessary to divide by the color information and the non-color information. For instance, suppose that there is a high correlation between the occurrence frequencies of three values of G, B and α among four values of RGB and α, whereas there is a low correlation between the occurrence frequencies of these three values and that of the R value. In this case, these three values of G, B and a may be stored in the lookup table 64, while only the R value may be appended to the index and provided directly. Like this, a correlation may be statistically evaluated between the occurrence frequencies of component values such as RGB and α in the area to be rendered. Some components with a comparatively low correlation to the other components may be appended to the index and given directly by no way of the lookup table 64. Thus, the component with the lowest correlation of the occurrence frequency among the image components might be directly provided without being stored in the lookup table 64 so that the efficiency of encoding the texture data can be improved.

In the above description, the structure of the lookup table 64 has been explained for the case where the texture unit 50 refers to the color palette for each texel. Alternatively, the lookup table may contain information other than the color information. For instance, information on the normal vector of the surface where the texture is mapped may be indexed, and the information on the normal vector may be stored in the lookup table in the numerical order of the index. The information on the normal vector will be used for bump mapping. Moreover, the values of the representative points of a nonlinear mathematical function may be indexed, and the values of the representative points may be stored in the lookup table in the numerical order of the index. In this case, the shader unit 30 obtains the coordinate values of the representative points by referring to the lookup table, and calculates a function value by interpolating between the representative points as appropriate. In these cases where the lookup table 64 is thus utilized for such various purposes, one component with a low correlation to the other components might be appended to the index and given directly instead of being stored in the lookup table 64 so that the capacity of the table can be efficiently used.

In the above description, the color lookup table stores the color value as an entry in the order of the index, however, the color lookup table may store both the index value and the color value in association. In this case, the lookup table reference unit 70 searches in the color lookup table using the index value of the texel as a key, and obtains a color value corresponding to the index value. Furthermore, the color lookup table may be configured in the form of a hash table. In this case, the lookup table reference unit 70 searches in the color lookup table based on a hash value for the index value.

The pixel processing such as texture mapping that uses the lookup table has been described in the embodiment, however, the lookup table having the similar structure can be also used for the geometry processing. For instance, the present invention may be applied to the lookup table to be referred to in displacement mapping. While the bump mapping that pseudo-applies ruggedness to the surface of the polygons by a mapping in the rendering process, the displacement mapping applies transformation to the surface of the polygons by directly operating the vertex data in the process of the geometry processing. Concretely, in the displacement mapping, vertex information that represents ruggedness is mapped to the polygon model. The data of normal vectors are mapped on the surface of the polygon which is the base of the object model, and as a result, the coordinate values of the vertices change in the directions given by the normal vectors and thereby more complex shape is generated. The present invention may be applied to such the displacement mapping. Among the vertex information, some components with a strong correlation to each other may be stored in the lookup table, while other components with a weak correlation may be appended to the index and provided directly.

1. An image generation apparatus comprising:
a lookup table which stores reference information in association with an index number; and
a reference unit which refers to said lookup table based on an inputted index value and thereby obtains the reference information corresponding to the index value,
wherein said lookup table stores a part of plural pieces of information necessary for performing an image generation processing and a remaining part of the plural pieces of said information which is not stored in said lookup table is appended to the index value so as to be provided directly.

2. The image generation apparatus of claim 1, wherein the part of the plural pieces of said information stored in said lookup table is a set of correlated pieces of said information with a relatively strong correlation to each other among the plural pieces of said information necessary for performing the image generation processing, and the remaining part of the plural pieces of said information appended to the index value is a less-correlated piece of said information with a weak correlation to the set of the correlated pieces of said information.

3. The image generation apparatus of claim 1, wherein the part of the plural pieces of said information stored in said lookup table is information describing pixel color, and the remaining part of the plural pieces of said information appended to the index value is information describing a property other than the pixel color.

4. The image generation apparatus of claim 2, wherein the part of the plural pieces of said information stored in said lookup table is information describing pixel color, and the remaining part of the plural pieces of said information appended to the index value is information describing a property other than the pixel color.

5. An image generation apparatus comprising:
a lookup table which stores reference information in association with an index number;
a separation unit which takes an index value and a non-index value separately out of an inputted value;
a reference unit which refers to said lookup table based on the index value and thereby obtains the reference information corresponding to the index value; and
a synthesizing unit which synthesizes the reference information and the non-index value.

6. The image generation apparatus of claim 5, wherein among plural pieces of information necessary for performing an image generation processing, a set of correlated pieces of said information with a relatively strong correlation to each other is stored as the reference information in said lookup table, and a less-correlated piece of said information with a weak correlation to the set of the correlated pieces of said information is provided as the non-index value.

7. The image generation apparatus of claim 5, wherein said reference information is information describing pixel color and said non-index value is information describing a property other than the pixel color, and said synthesizing unit obtains information indicating a property of the pixel by synthesizing said reference information and said non-index value.

8. The image generation apparatus of claim 6, wherein said reference information is information describing pixel color and said non-index value is information describing a property other than the pixel color, and said synthesizing unit obtains information indicating a property of the pixel by synthesizing said reference information and said non-index value.

9. The image generation apparatus of claim 7, wherein said non-index value is a value related to pixel transparency.

10. The image generation apparatus of claim 7, wherein said non-index value is a value related to pixel reflectance.

11. An image generation apparatus comprising:
a lookup table which stores reference information related to a texture in association with an index number;
a separation unit which takes an index value and a non-index value separately out of an inputted value;
a reference unit which refers to said lookup table based on the index value and thereby obtains the reference information corresponding to the index value; and
a computation unit which processes texture data by utilizing said non-index value as information related to the texture, in addition to said reference information obtained by the reference unit.

12. The image generation apparatus of claim 11, wherein said reference information is information describing pixel color and said non-index value is information describing a property other than the pixel color.

13. An image generation method comprising:
receiving an input of an index value with additional information attached;
referring to a lookup table which stores reference information necessary for performing an image generation processing in association with an index number and thereby obtaining the reference information corresponding to the inputted index value; and
performing the image generation processing by using a combination of the obtained reference information and said additional information.

14. An image generation method comprising:
taking an index value and a non-index value separately out of an inputted value;
referring to a lookup table, which stores reference information necessary for performing an image generation processing, based on said index value and thereby obtaining said reference information corresponding to said index value; and
performing the image generation processing by using said reference information and said non-index value.

15. An image generation method comprising encoding image information given by an index form, wherein said image information is configured such that a part of plural pieces of information necessary for performing an image generation processing is stored in a lookup table and a remaining part of the plural pieces of said information which is not stored in said look up table is appended to an index value for referring to said lookup table.

16. A data structure of an image comprising encoded image information given by an index form, wherein said image information is configured such that a part of plural pieces of information necessary for performing an image generation processing is stored in a lookup table, and a remaining part of the plural pieces of said information which is not stored in said look up table is appended to an index value for referring to said lookup table.

17. A data structure of a texture image comprising encoded image information given by an index form, wherein said image information is configured such that information describing a property other than texture color is appended to an index value for referring to a lookup table which stores information describing the texture color.
